(19) United States
(12) Patent Application Publication
(10) Pub. No.: US 2003/0080904 A1
(43) Pub. Date: May 1, 2003

(54) Compact printed antenna

(75) Inventor: Tailee Chen, Taipei (TW)

Correspondence Address: BRUCE H. TROXELL, SUITE 1404, 5205 LEESBURG PIKE, FALLS CHURCH, VA, 22041, US

(73) Assignee: GemTek Technology Co., Ltd.

(21) Appl. No.: 10/119,215

(22) Filed: Apr. 10, 2002

(30) Foreign Application Priority Data
Oct. 29, 2001 (TW) 90126682

(51) Int. Cl. H01Q 1/38

(52) U.S. Cl. 343/700 MS; 343/846; 343/895

(57) ABSTRACT

A compact printed antenna includes a substrate and a printed circuit on the substrate. The printed circuit includes a ground metal, a helical metal, a short circuit leg and a feeding leg. The ground metal has a feeding structure. The helical metal includes a plurality of conductive apertures to connect a plurality of metal strips to form a flat helical structure. The helical metal is parallel with the ground metal and has a short circuit end and an open circuit end to form an open circuit-short circuit structure. The short circuit end connects the ground metal through the short circuit leg. The feeding leg is extended outwards from a selected location on the helical metal to further connect a matching circuit. By providing the compact printed antenna, the flat helical structure of the helical metal can be shrunk in size, an inductance to allow the antenna making desired adjustment for the input impedance can be generated, and the adjustment freedom upon coupled impedance for the antenna can be increased.

### FIELD OF THE INVENTION

The present invention relates to a compact printed antenna and more particularly to an improved printed and leveled F-type antenna which can shrink antenna size and increase coupling freedom.

### BACKGROUND OF THE INVENTION

Rapid innovation and development upon wireless communication technology have made mobile communication products as one of the mainstream products nowadays. These mobile communication products include mobile phones, PDA, notebook computers, etc. They can couple with proper communication modules for linking a Local Area Network (LAN) to transmit and receive e-mail, and to receive instant information (such as news, stocks quotations, and so on) for sharing resources and transmitting data. In the art, the flat and leveled F-type antennas have the advantages of slim size and light weight, thus have been widely adopted as built-in antennas in most of the mobile communication products.

Generally, the leveled F-type antennas can be categorized into a real type and a virtual type. The real type antenna utilizes a conductive wire or a flat plate, and includes a feeding leg and a short circuit leg to construct the antenna as a leveled F. On the other hand, the virtual type antenna which functions like a real type leveled F-type antenna is formed substantially as a leveled F-shaped antenna on a printed circuit board (PCB), and can include a feeding leg, a short circuit leg, and an open circuit end for receiving and transmitting signals.

Referring now to FIG. 1 for a conventional compact printed antenna, the antenna includes a substrate 10, a ground metal 11, a strip metal 12, a short circuit leg 14 and a feeding leg 16; in which the ground metal 11, the strip metal 12, the short circuit leg 14 and the feeding leg 16 are all printed circuits located on the substrate 10.

The ground metal 11 has a feeding structure 15 which presents a coplanar wave guide (CPW) feeding structure as shown in FIG. 1. The feeding leg 16 is formed as an elongated metal strip 12 extending outwards to pass the feeding structure 15 for further connecting to a matching circuit (not shown in the drawing). The feeding leg 16 and the ground metal 11 are not connected with each other so as to avoid a short circuit problem. The strip metal 12 is parallel with the ground metal 11. The short circuit leg 14 is located at one end (a short circuit end) of the strip metal 12 and extends to connect with the ground metal 10 for forming an open circuit-short circuit structure with another end of the strip metal 12. The distance between the open circuit end and the short circuit end is preferably one quarter of the wavelength.

As the surface size of the compact printed antenna has a restriction that limits the length of the strip metal 12 equal to one quarter of the wavelength, the size of the antenna is thereby limited to a constant range of one quarter of the wavelength and thus cannot be shrunk effectively. It is well known that the development of passive elements in the contemporary integrated circuits has been gradually moving towards the trend of miniaturization. However, the antenna size of the communication products is still restricted by the one quarter of signal wavelength limitation and cannot be reduced. Therefore, it becomes a big technology bottleneck that requires improvement.

### SUMMARY OF THE INVENTION

The primary object of the invention is to provide a compact printed antenna for effectively shrinking the size of the antenna.

Another object of the invention is to provide a compact printed antenna for increasing the freedom of coupling antenna impedance.

In a first embodiment of the invention, the compact printed antenna includes a substrate and a printed circuit on the substrate. The printed circuit includes a ground metal, an undulant metal, a short circuit leg and a feeding leg. The ground metal has a feeding structure. The undulant metal, extending in a direction parallel with the ground metal, has a short circuit end and an open circuit end for forming an open circuit-short circuit structure. The short circuit end connects the ground metal through the short circuit leg. The feeding leg is extended outwards from a selected location on the undulant metal and further passing through the feeding structure to connect a matching circuit. The feeding leg and ground metal do not connect with each other to prevent short circuit problems.

In a second embodiment of the invention, the compact printed antenna includes a substrate and a printed circuit on the substrate. The printed circuit includes a ground metal, a helical metal, a short circuit leg and a feeding leg. The ground metal has a feeding structure. The helical metal has a plurality of conductive apertures and a plurality of metal strips connecting together to form a flat helical structure. The helical structure is extended in a direction parallel with the ground metal and has a short circuit end and an open circuit end for forming an open circuit-short circuit structure. The short circuit end connects the ground metal through the short circuit leg. The feeding leg is extended outwards from a selected location on the helical metal and passing through the feeding structure to connect a matching circuit. Also, the feeding leg and ground metal do not connect with each other to avoid a possible short circuit problem.

The undulant metal and helical metal of the invention can maintain the feeding circuit length equivalent to one quarter of the wavelength, and hence the present invention can shorten the linear distance between the open circuit end and short circuit end to effectively reduce the size of the compact printed antenna. In addition, the undulant metal and the helical metal of the invention can generate inductance to adjust the input impedance of the antenna so as to increase the freedom of coupling antenna impedance.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 a schematic view of a conventional compact printed antenna;

FIG. 2 is a schematic view of a first embodiment of the compact printed antenna of the invention; and

FIG. 3 is a schematic view of a second embodiment of the compact printed antenna of the invention.

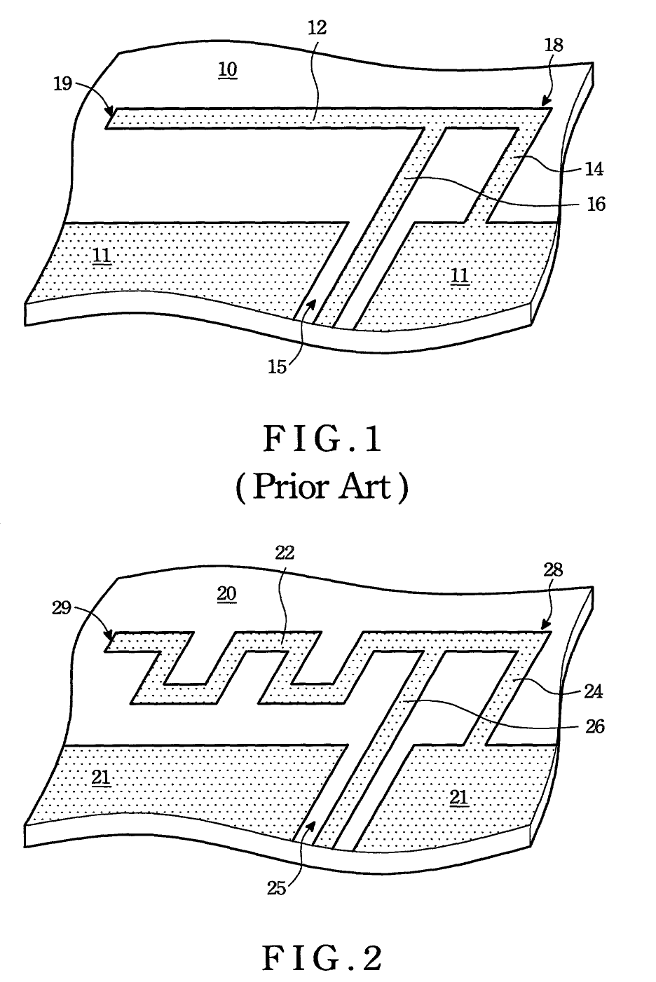

### DESCRIPTION OF THE PREFERRED EMBODIMENTS

The invention aims to provide an improved compact printed antenna design for effectively shrinking the antenna size to facilitate miniaturization of communication products, and also to allow the antenna generating inductance to increase freedom of adjusting coupled impedance.

Referring now to FIG. 2 for a first embodiment of the invention, the compact printed antenna of the invention includes a substrate 20, a ground metal 21, an undulant metal 22, a short circuit leg 24 and a feeding leg 26. The ground metal 21, the undulant metal 22, the short circuit leg 24 and the feeding leg 26 are formed as printed circuits located on the substrate 20. The ground metal 21 has a feeding structure 25. The undulant metal 22 is extended in a direction parallel with the ground metal 21 and is formed by an elongated metal strip bending in an undulant structure or made of a sheet of metal by punching into an undulant structure. The undulant metal 22 has a short circuit end 28 and an open circuit end 29 to form an open circuit-short circuit structure. The short circuit end 28 connects the ground metal 21 through the short circuit leg 24. The feeding leg 26 is extended outwards from a selected location on the undulant metal 22 and further passing through the feeding structure 25 of the ground metal 21 to connect a matching circuit (not shown in the drawing) to generate a matching impedance. The feeding leg 26 and the ground metal 21 do not connect with each other so as to prevent short-circuiting from happening.

The distance between the open circuit end 29 and the short circuit end 28 of the antenna is preferably one quarter of the wavelength that is the equivalent current path length of the open circuit-short circuit oscillation signal. Hence, under the condition that the equivalent current path length equals to one quarter of the wavelength, the linear distance between the open circuit end 29 and the short circuit end 28 of the undulant metal strip 22 can be shortened. As a result, the size of the compact printed antenna can be effectively reduced.

Furthermore, the undulant structure of the undulant metal strip 22 will generate inductance and internal impedance that may be changed and adjusted through altering the number of undulation of the undulant structure. Hence, the compact printed antenna can be appropriately adjusted to meet individual applicable spectrum, grounding metal format and antenna input impedance so as to increase the freedom of coupling impedance generated through connecting the matching circuit.

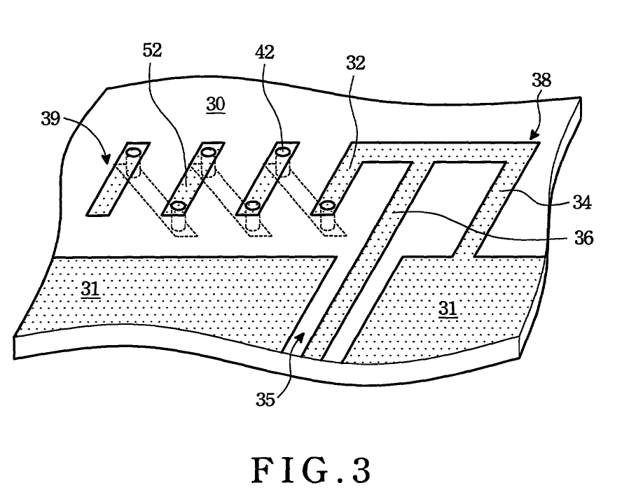

Referring to now FIG. 3 for a second embodiment of the invention, the compact printed antenna of the invention includes a substrate 30, a ground metal 31, a helical metal 32, a short circuit leg 34 and a feeding leg 36. The ground metal 31, the helical metal 32, the short circuit leg 34 and the feeding leg 36 are made as printed circuits located on the substrate 30. The ground metal 31 has a feeding structure 35. The helical metal 32 is extended in a direction parallel with the ground metal 31 and has a short circuit end 38 and an open circuit end 39 so as to form an open circuit-short circuit structure. The short circuit end 38 connects the ground metal 31 through the short circuit leg 34. The feeding leg 36 is extended outwards from a selected location on the helical metal 32 and further passing through the feeding structure 35 of the ground metal 31 to connect a matching circuit (not shown in the drawing) for generating a matching impedance. The feeding leg 36 and the ground metal 31 do not connect with each other to avoid any the possibility of short-circuiting.

The helical metal 32 is a flat helical structure formed by a plurality of conductive apertures 42 connecting to a plurality of metal strips 52. The conductive apertures 42 run through metal legs located on the positive side and negative side of the substrate 30. The metal legs may be hollow or solid conductive apertures. The metal strip 52 can be formed as a strip type printed circuit located on the positive side or the negative side of the substrate 30.

The distance between the open circuit end 39 and the short circuit end 38 is preferably one quarter of the wavelength that is the equivalent current path length of the open circuit-short circuit oscillation signal. Hence, under the condition of the equivalent current path length equal to one quarter of the wavelength, the linear distance between the open circuit end 39 and the short circuit end 38 of the helical metal strip 32 can be shortened. As a result, the size of the compact printed antenna can be effectively reduced.

Furthermore, the flat helical structure of the helical metal 32 will generate inductance and internal impedance that can be appropriately changed and adjusted through altering the number of helix of the helical structure. Thus, the compact printed antenna can be easily manufactured according to individual applicable spectrums, grounding metal formats and antenna input impedance. Also, the freedom of coupling impedance generated through connecting the matching circuit can be thereby increased as desired.

In summary, the compact printed antenna of the invention provides at least the following advantages over the conventional techniques:

1. The undulant metal and the helical metal structure can maintain equivalent current path length to one quarter of the wavelength, and thereby the size of the antenna can be effectively shrunk.

2. The undulant metal and the helical metal can generate sufficient inductance to adjust the antenna input impedance so that the increasing upon the freedom of the F-type antenna coupling impedance is possible.

While the preferred embodiments of the inventions have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A compact printed antenna, comprising:
a substrate, for fabricating printed circuits;
a ground metal, formed on the substrate;
an undulant metal, formed on the substrate, extending in a direction parallel with the ground metal, further having thereof a short circuit end and an open circuit end;
a short circuit leg, for connecting electrically the short circuit end of the undulant metal with the ground metal; and
a feeding leg, extending from a selected location of the undulant metal to couple with a matching circuit on the substrate.

2. The compact printed antenna of claim 1, wherein the ground metal, the undulant metal, the short circuit leg and the feeding leg are printed circuits located on the substrate.

3. The compact printed antenna of claim 1, wherein the equivalent current path length of the open circuit end and the short circuit end is one quarter of a selected wavelength to form an open circuit-short circuit structure.

4. The compact printed antenna of claim 1, wherein the undulant structure of the undulant metal generates inductance to form internal impedance and increase adjustment freedom of input impedance of the antenna.

5. A compact printed antenna, comprising:
a substrate, for fabricating printed circuits;
a ground metal, formed on the substrate;
a helical metal, formed on the substrate and extending in a direction parallel with the ground metal, further having thereof a short circuit end, an open circuit end and a plurality of conductive apertures connecting to a plurality of metal strips to form a flat helical structure;
a short circuit leg, for connecting the short circuit end of the helical metal with the ground metal; and
a feeding leg, extending from a selected location of the helical metal to couple with a matching circuit on the substrate.

6. The compact printed antenna of claim 5, wherein the ground metal, the helical metal, the short circuit leg and the feeding leg are printed circuits located on the substrate.

7. The compact printed antenna of claim 5, wherein the equivalent current path length of the open circuit end and the short circuit end is one quarter of a selected wavelength to form an open circuit-short circuit structure.

8. The compact printed antenna of claim 5, wherein the conductive apertures are hollow metal legs running through a positive side and a negative side of the substrate.

9. The compact printed antenna of claim 5, wherein the conductive apertures are solid metal legs running through a positive side and a negative side of the substrate.

10. The compact printed antenna of claim 5, wherein the metal strips are strip type printed circuits located on a positive side and a negative side of the substrate.

11. The compact printed antenna of claim 5, wherein the flat helical structure of the helical metal generates inductance to form internal impedance and increase adjustment freedom upon input impedance of the antenna.
